(19) United States
(12) Patent Application Publication
(10) Pub. No.: US 2025/0000149 A1
(43) Pub. Date: Jan. 2, 2025

(54) CARTRIDGE AND AEROSOL-GENERATING DEVICE INCLUDING THE SAME

(71) Applicant: KT&G CORPORATION, Daejeon (KR)

(72) Inventors: Taehun KIM, Yongin-si Gyeonggi-do (KR); Jueon PARK, Seoul (KR); Hyungjin JUNG, Seoul (KR); Jungho HAN, Daejeon (KR)

(73) Assignee: KT&G CORPORATION, Daejeon (KR)

(21) Appl. No.: 18/698,620

(22) PCT Filed: Oct. 14, 2022
(86) PCT No.: PCT/KR2022/015645

§ 371 Date: Apr. 4, 2024

(30) Foreign Application Priority Data
Oct. 20, 2021 (KR) 10-2021-0140612
Feb. 15, 2022 (KR) 10-2022-0019691
May 16, 2022 (KR) 10-2022-0059802

(51) Int. Cl. A24F 40/46; A24F 40/10; A24F 40/42; A24F 40/44; H05B 3/12; H05B 3/74

(52) U.S. Cl. CPC A24F 40/46; A24F 40/10; A24F 40/42; A24F 40/44; H05B 3/12; H05B 3/74

(57) ABSTRACT

A cartridge and an aerosol-generating device including the same are disclosed. The cartridge of the disclosure includes a first chamber configured to store liquid; a second chamber configured to allow air to pass therethrough; a wick extending across the second chamber and configured to receive the liquid from the first chamber; and a heating coil configured to heat the wick, wherein the wick is a silica wick, and wherein the heating coil has an electrical resistance in a range of 1.0 ohm to 1.3 ohms.

### TECHNICAL FIELD

The present disclosure relates to a cartridge and an aerosol-generating device including the same.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to improve user satisfaction with puffing.

It is still another object of the present disclosure to reduce excessive power consumption.

### Solution to Problem

In accordance with an aspect of the present disclosure for accomplishing the above and other objects, there is provided a cartridge including a first chamber configured to store liquid; a second chamber configured to allow air to pass therethrough; a wick extending across the second chamber and configured to receive the liquid from the first chamber; and a heating coil configured to heat the wick, wherein the wick is a silica wick, and wherein the heating coil has an electrical resistance in a range of 1.0 ohm to 1.3 ohms.

### Advantageous Effects of Invention

According to at least one of embodiments of the present disclosure, it may be possible to improve user satisfaction with puffing.

According to at least one of embodiments of the present disclosure, it may be possible to reduce excessive power consumption.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

FIGS. 1 to 9 are views showing examples of an aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

With respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

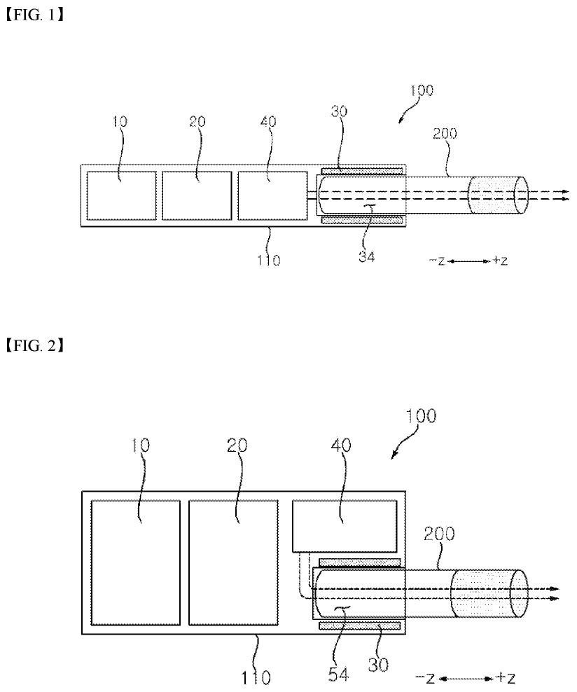

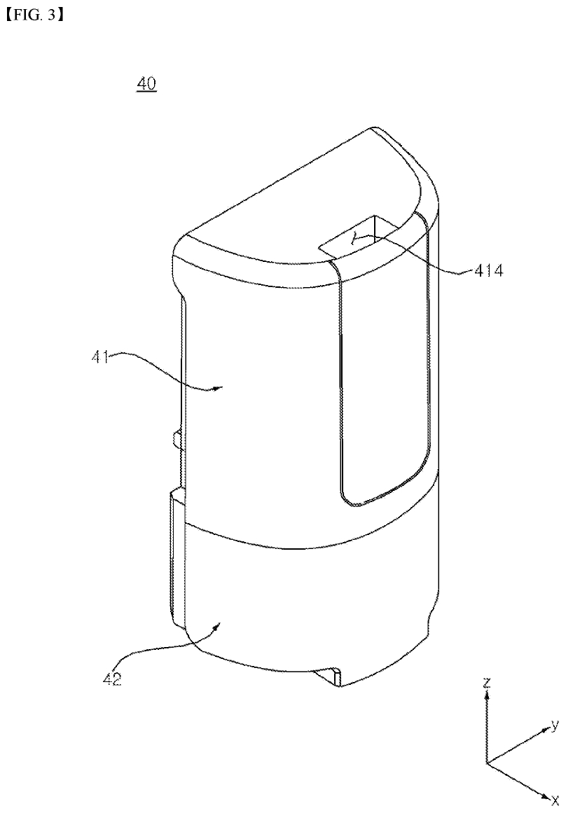

Referring to FIGS. 1 and 2, an aerosol-generating device 100 may include at least one of a battery 10, a controller 20, a heater 30, or a cartridge 40. At least one of the battery 10, the controller 20, the heater 30, or the cartridge 40 may be disposed in a body 110 of the aerosol-generating device 100.

The body 110 may have an insertion space 34 defined therein to allow a stick 200 to be inserted thereinto. The insertion space 34 may be open upwards. The insertion space 34 may have a cylindrical shape that is elongated in the vertical direction. The heater 30 may be formed around the insertion space 34. For example, the heater 30 may surround the insertion space 34.

Referring to FIG. 1, the battery 10, the controller 20, the cartridge 40, and the heater 30 may be disposed in a line. Referring to FIG. 2, the cartridge 40 and the heater 30 may be disposed parallel to each other so as to face each other. The internal structure of the aerosol-generating device 100 is not limited to that shown in the drawings.

The battery 10 may supply power to operate at least one of the controller 20, the heater 30, or the cartridge 40. The battery 10 may supply power required for driving a display, a sensor, a motor, etc. mounted in the aerosol-generating device 100.

The controller 20 may control the overall operation of the aerosol-generating device 100. The controller 20 may control the operation of at least one of the battery 10, the heater 30, or the cartridge 40. The controller 20 may control the operation of the display, the sensor, the motor, etc. mounted in the aerosol-generating device 100. The controller 20 may check the state of each of the components of the aerosol-generating device 100 to determine whether the aerosol-generating device 100 is in an operable state.

The heater 30 may generate heat using power supplied from the battery 10. The heater 30 may heat the stick 200 inserted into the insertion space 34.

The cartridge 40 may generate an aerosol. The aerosol generated in the cartridge 40 may be delivered to a user via the stick 200 inserted into the aerosol-generating device 100.

The lower portion of the stick 200 may be inserted into the insertion space 34, and the upper portion thereof may be exposed to the outside. The user may inhale air in the state of holding the upper portion of the stick 200 in the mouth. When the user inhales air through the stick 200, air may be introduced into the cartridge 40, and may then be delivered to the user via the insertion space 34 and the stick 200 inserted into the insertion space 34 together with an aerosol.

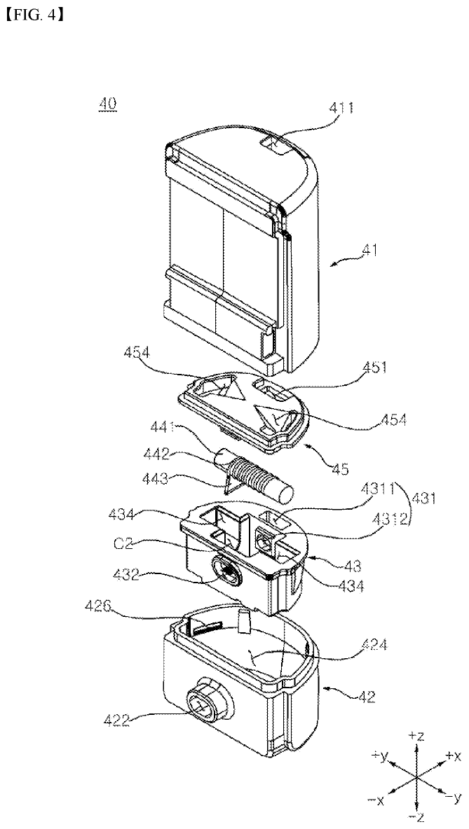

Referring to FIG. 3, the cartridge 40 may include a first container 41 and a second container 42. The second container 42 may be coupled to the lower side of the first container 41. A cartridge inlet 414 may be formed in such a manner than one side of the cartridge 40 is open. The cartridge inlet 414 may be formed in such a manner than the upper end of the first container 41 is open. The cartridge inlet 414 may communicate with the outside. Air outside the cartridge 40 may be introduced into the cartridge 40 through the cartridge inlet 414.

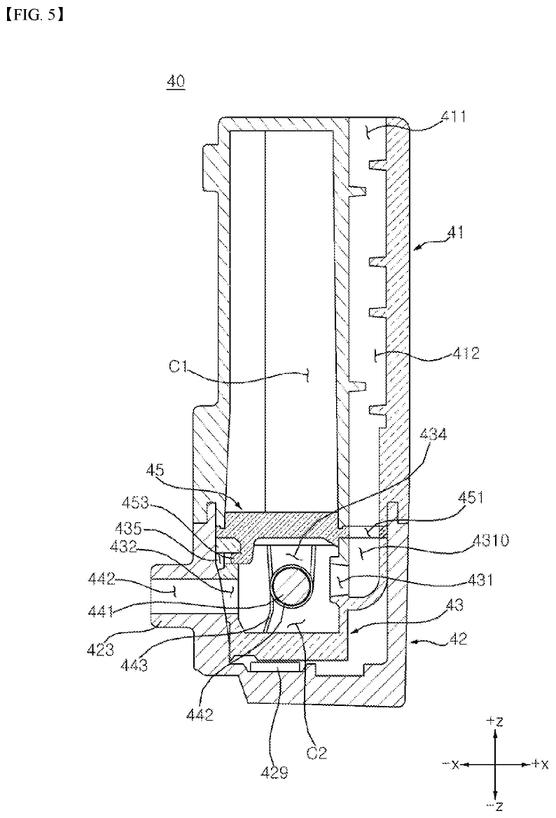

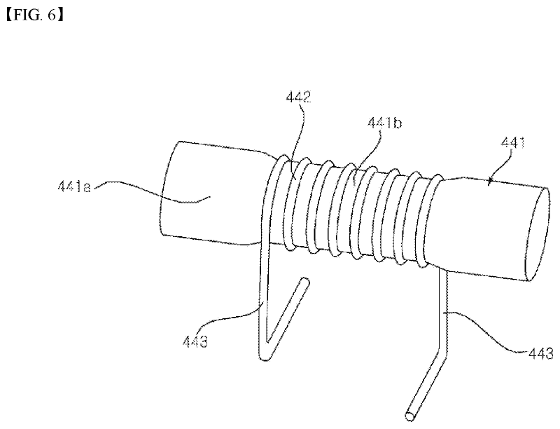

Referring to FIGS. 4 to 6, the cartridge 40 may include the first container 41 and the second container 42. The first container 41 may be coupled to the upper side of the second container 42. A plate 45 may be disposed between the first container 41 and the second container 42 or between the first container 41 and a frame 43 so as to be coupled thereto.

The first container 41 may have a first chamber C1 to store liquid therein. The first container 41 may surround the first chamber C1, and the lower portion of the first chamber C1 may be open. The opening in the first chamber C1 may be covered by the plate 45.

The first container 41 may have therein an inflow passage 412 through which air passes. The first chamber C1 and the inflow passage 412 may be separated from each other. The inflow passage 412 may be elongated vertically in one side of the first container 41. The first chamber C1 and the inflow passage 412 may be formed parallel to each other.

The first container 41 may have a cartridge inlet 411. The cartridge inlet 411 may be formed in such a manner than the upper portion of the first container 41 is open, and may communicate with the inflow passage 412. The cartridge inlet 411 may communicate with the upper end of the inflow passage 412. The lower end of the inflow passage 412 may communicate with a connecting hole 451, a frame passage 4310, and a chamber inlet 431.

The second container 42 may be coupled to the lower portion of the first container 41. The second container 42 may have therein a space 424 having an open top and a covered bottom. The frame 43 may be accommodated in the space 424 in the second container 42.

The second container 42 may have a cartridge outlet 422. The cartridge outlet 422 may be formed in a lateral portion of one side of the second container 42. The cartridge outlet 422 may be formed in a discharge port 423, which protrudes in the thickness direction from the lateral portion of the second container 42. The cartridge outlet 422 may communicate with the space 424 in the second container 42.

The frame 43 may be inserted into the space 424 in the second container 42 to be coupled to the second container 42. A fastening member 426, which protrudes from the side wall of the second container 42 to the space 424, may be fastened to the frame 43 in order to fix the frame 43.

The frame 43 may have therein a second chamber C2. The frame 43 may surround the second chamber C2, and the upper portion of the second chamber C2 may be open. The upper portion of the second chamber C2 may be covered by the plate 45.

The frame 43 may have a chamber inlet 431. The chamber inlet 431 may be formed in such a manner that one surface of the side wall surrounding the second chamber C2 is open. The chamber inlet 431 may communicate with the second chamber C2. The frame passage 4310 may be open in the upward direction of the frame 43. The chamber inlet 431 may be connected to one end of the frame passage 4310. The frame passage 4310 may extend downwards from the upper end of the frame passage 4310, and may extend to the chamber inlet 431 in a curved manner.

The frame 43 may have a chamber outlet 432. The chamber outlet 432 may be formed in a lateral portion of one side of the frame 43. The chamber outlet 432 may communicate with the second chamber C2. The chamber outlet 432 may be formed in a port protruding in the thickness direction from the lateral portion of the frame 43. The chamber outlet 432 may communicate with the second chamber C2. The chamber outlet 432 may be formed at a position corresponding to the cartridge outlet 422. The chamber outlet 432 may be formed at a position opposite the second chamber inlet 431 with respect to the second chamber C2. When the frame 43 is coupled to the second container 42, the chamber outlet 432 and the cartridge outlet 422 may communicate with each other.

The frame 43 may have therein a wick groove 434. The wick groove 434 may communicate with the second chamber C2. The wick groove 434 may be formed in such a manner that the second chamber C2 is depressed in one direction. The wick groove 434 may be formed in a pair. The pair of wick grooves 434 may be formed in two opposite sides of the second chamber C2. The pair of wick grooves 434 may be opposite each other with respect to the second chamber C2. The upper portions of the wick grooves 434 may be open.

A wick 441 may have a cylindrical shape that is elongated in the lateral direction of the second chamber C2. Both ends of the wick 441 may be respectively inserted into and located in the pair of wick grooves 434. The central portion of the wick 441 may be located in the second chamber C2. The wick 441 may extend from one side of the second chamber C2 to the other side thereof. The wick 441 may be connected to the first chamber C1 to receive liquid from the first chamber C1. The wick 441 may be fixedly located in the wick grooves 434 due to the frame 43 and the plate 45.

A heating coil 442 may be wound around the central portion of the wick 441. The heating coil 442 may be wound in the longitudinal direction of the wick 441. The heating coil 442 may be disposed in the second chamber C2. The heating coil 442 may be located between the pair of wick grooves 434.

The heating coil 442 may be an electrically resistive heater. The heating coil 442 may generate heat due to the internal resistance thereof upon receiving current, and the heat may be emitted outside. The heating coil 442 may generate heat to heat the wick 441. The heating coil 442 may be conductive.

A lead 443 may be electrically connected to an end of the heating coil 442. The lead 443 may be provided in a pair, and the pair of leads 443 may be electrically connected to both ends of the heating coil 442. The leads 443 may extend to the outside of the wick 441 from the ends of the heating coil 442. The leads 443 may pass through the bottom of the frame 43 to be electrically connected to electrodes disposed on the bottom of the second container 42. The battery 10 may sequentially apply current to the leads 443 and the heating coil 442 to cause the heating coil 442 to generate heat. The leads 443 may be conductive.

The heating coil 442 and the leads 443 may be made of different materials. The leads 443 may be made of a material having lower resistance than that of the heating coil 442. The leads 443 may be made of a material having a lower temperature coefficient of resistance (TCR) than that of the heating coil 442. The heating coil 442 may be made of a material having a relatively high TCR, and the leads 443 may be made of a material having a relatively low TCR.

For example, the heater 30 and the heating coil 442 may include any one of Kanthal, nichrome, and stainless steel. The heater 30 may include 316L stainless steel, which is one grade of stainless steel. For example, the leads 443 may include any one of nickel, gold, and silver. However, the materials of the heating coil 442 and the leads 443 are not limited to the aforementioned materials.

Accordingly, when current flows therethrough, the leads 443 may have relatively small variation in resistance and high stability with respect to resistance.

The heater 30 may include 316L stainless steel, which is one grade of stainless steel. 316L stainless steel is a low-carbon steel, which has excellent intergranular corrosion resistance and heat resistance. Accordingly, the heater 30 may be more stable in the internal environment of the cartridge, in which temperature and humidity are high.

The plate 45 may be disposed between the first container 41 and the second container 42 or between the first container 41 and the frame 43 so as to be coupled thereto. The plate 45 may cover and seal the open portion of the first chamber C1. The plate 45 may cover the upper portion of the frame 43. The plate 45 may cover and seal the open portion of the second chamber C2. The plate 45 may be disposed between the first chamber C1 and the second chamber C2, and may separate the first chamber C1 and the second chamber C2 from each other.

The plate 45 may have a connecting hole 451 formed in one side thereof. The connecting hole 451 may be located between the inflow passage 412 and the frame passage 4310. The connecting hole 451 may connect the inflow passage 412 and the frame passage 4310 to each other.

The plate 45 may have a liquid inlet hole 454 formed therein. The liquid inlet hole 454 may be formed in a pair at positions corresponding to the wick grooves 434. The pair of liquid inlet holes 454 may be located above both ends of the wick 441. The liquid inlet holes 454 may connect the first chamber C1 and the wick grooves 434 to each other. The wick 441 may be connected to the first chamber C1 through the liquid inlet holes 454.

A hook recess 435 may be formed above the chamber outlet 432 at a position adjacent to the chamber outlet 432. A hook 453 may protrude downwards from one side of the plate 45. The hook 453 may be inserted and fastened into the hook recess 435 formed in the upper portion of the frame 43. The plate 45 may be fastened to the frame 43, and the first container 41 coupled to the second container 42 may press the edge of the plate 45 toward the frame 43.

Air may be introduced into the cartridge 40 through the cartridge inlet 411, and may be discharged to the outside of the cartridge 40 through the cartridge outlet 422. The air introduced into the cartridge 40 may sequentially pass through the inlet passage 412, the connecting hole 451, the frame passage 4310, the chamber inlet 431, the second chamber C2, the chamber outlet 432, and the cartridge outlet 422, and may then be discharged outside.

When the heating coil 442 generates heat to heat the wick 441, an aerosol may be generated from the wick 441 in the second chamber C2. The air passing through the cartridge 40 may be discharged through the cartridge outlet 422 from the second chamber C2 together with the aerosol.

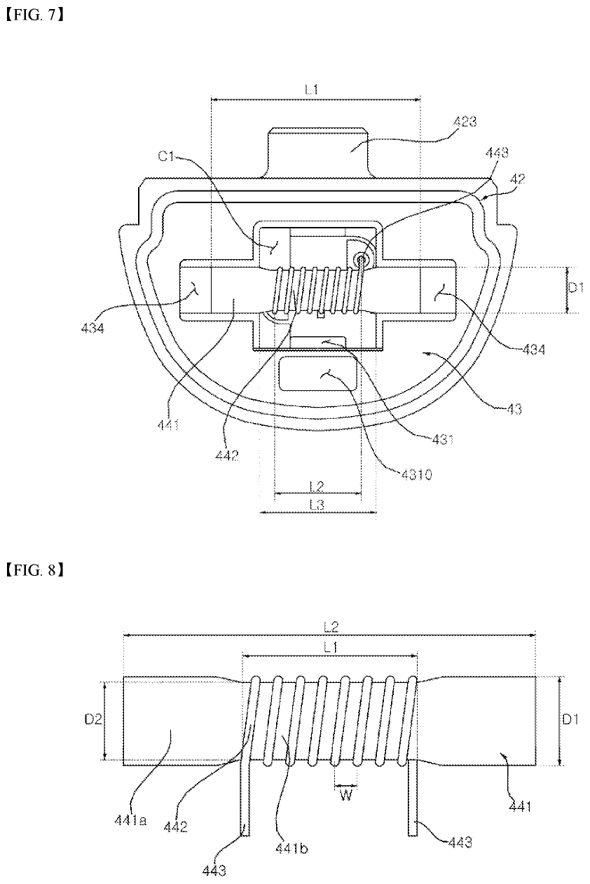

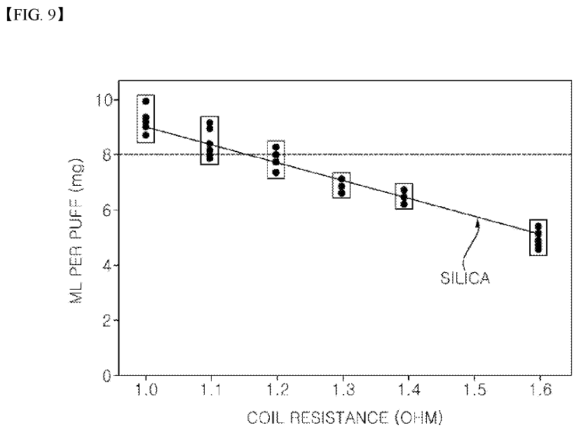

Referring to FIGS. 7 and 8, the pair of wick grooves 434 may be formed in both sides of the second chamber C2. The distance L3 between the pair of wick grooves 434 may be defined as the distance between the inner ends of the pair of wick grooves 434 in the longitudinal direction of the wick 441. The distance L3 between the pair of wick grooves 434 may be equal to the distance L3 from one side of the second chamber C2 to the other side thereof or the width 13 of the second chamber C2. For example, the distance L3 between the pair of wick grooves 434 may be about 4.5 mm to about 5.4 mm. In another example, the distance L3 between the pair of wick grooves 434 may be about 4.9 mm.

The wick 441 may be elongated in one direction. The wick 441 may include peripheral portions 441a and a central portion 441b. The peripheral portions 441a may be formed at both ends of the wick 441, and the central portion 441b may be formed between the pair of peripheral portions 441a.

Each of both ends of the wick 441 may be inserted into a respective one of the pair of wick grooves 434. Each of the pair of peripheral portions 441a may be located in a respective one of the pair of wick grooves 434, and the central portion 441b may be located in the second chamber C2. The wick 441 may extend from one of the wick grooves 434 to the other thereof. The length L1 of the wick 441 may be longer than the distance L3 between the pair of wick grooves 434. For example, the length L1 of the wick 441 may be about 6 mm to about 12 mm. In another example, the length of the wick 441 may be about 8 mm to about 10 mm. In another example, the length L1 of the wick 441 may be about 9 mm.

The wick 441 may be wet upon receiving liquid from the first chamber C1 (refer to FIG. 5). The wick 441 may be made of a material selected in consideration of liquid absorption capability and heat resistance. For example, the wick 441 may be a cotton wick made of cotton. In another example, the wick 441 may be a silica wick made of silica fiber. The silica wick may contain silicon dioxide in an amount of 90% or more. The cotton wick may have higher liquid absorption capability than the silica wick. However, the silica wick does not melt even at a high temperature of 1400 degrees Celsius, and has a heat resistance range of about 700 degrees Celsius. That is, the silica wick may exhibit higher heat resistance than the cotton wick. When the wick 441 is a silica wick, it is possible to prevent a user from feeling an unpleasant burnt taste due to burning of the wick 441 by the heat generated from the heating coil 442 and to realize a favorable taste.

The heating coil 442 may be wound around the central portion 441b of the wick 441 in the longitudinal direction of the wick 441. The central portion 441b may be disposed inside the heating coil 442, and the peripheral portions 441a may be disposed outside the heating coil 442.

The length L2 of the heating coil 442 may be defined as a length in the longitudinal direction of the wick 441. The heating coil 442 may be disposed in the second chamber C2. The length L2 of the heating coil 442 may be determined in consideration of the distance L3 from one of the wick grooves 434 to the other thereof. The length L2 of the heating coil 442 may be shorter than the distance L3 from one of the wick grooves 434 to the other thereof, along which the wick 441 extends. For example, the heating coil 442 may have a length L2 of about 3.0 mm to about 3.5 mm in the longitudinal direction of the wick 441. In another example, the length L2 of the heating coil 442 may be about 3.25 mm. The length of the central portion 441b of the wick 441 may be equal or similar to the length L2 of the heating coil 442. Accordingly, the range within which the wick 441 is atomized in the second chamber C2 may be increased.

FIG. 9 is a graph schematically showing the amount of aerosol generated by the wick 441, in which the liquid from the first chamber C1 is absorbed, and the heating coil 442. The amount of aerosol generated from the wick 441 may be characterized by a mass loss (ML) (milligrams) per puff. This may correspond to reduction in mass measured with respect to the cartridge 40, which results from a machine puff having fixed characteristics and fixed voltage being applied to the heating coil 442. In terms of user satisfaction, a mass loss per puff of 8 mg is considered a desirable target.

The wick 441 is a wick made of silica fiber, that is, a silica wick. FIG. 9 shows results obtained when a silica wick and heating coils 442 having resistance values of 1.0 ohm, 1.1 ohms, 1.2 ohms, 1.3 ohms, 1.4 ohms, 1.5 ohms, and 1.6 ohms are used. FIG. 9 shows a plurality of values obtained by measuring a mass loss per puff while applying the same voltage to heating coils 442 having different resistance values. In addition, FIG. 9 shows a changing tendency of the mass loss per puff by connecting the average values thereof to each other.

It can be seen that the higher the resistance of the coil, the smaller the amount of power consumed for each puff. As the resistance value of the heating coil 442 decreases, the temperature of the coil increases, leading to smooth generation of an aerosol. However, the liquid may taste burnt due to excessive increase in temperature, and the amount of power consumed by the device may be increased. On the other hand, as the resistance value of the heating coil 442 increases, the amount of power consumed by the device may be reduced, but a sufficient amount of aerosol may not be generated.

The heating coil 442 may have a resistance of about 1.0 ohm to about 1.3 ohms. In another example, the heating coil 442 may have a resistance of about 1.1 ohms to about 1.25 ohms. In another example, the heating coil 442 may have a resistance of about 1.1 ohms. In this case, the electrical resistance of the cartridge assembly may include a value of 1.20 ohms to 1.25 ohms. Accordingly, the target mass loss per puff of 8 mg may be substantially achieved.

Referring to FIGS. 7 to 9, the resistance value of the heating coil 442 may be influenced by the magnetic permeability according to the material of the heating coil 442, the number of windings of the heating coil 442 around the wick 441, the thickness (gauge) of the wire of the heating coil 442, the length L2 of the heating coil 442, and the area of a region surrounded by the heating coil 442. As the number of windings of the heating coil 442 around the wick 441 increases, as the gauge of the heating coil 442 increases, as the length L2 of the heating coil 442 decreases, and as the area of a region of the wick 441 that is surrounded by the heating coil 442 increases, the magnitude of the resistance value of the heating coil 442 may increase. The heating coil 442 may be configured such that the resistance value thereof ranges from 1.0 ohm to 1.3 ohms within the range of the length L2. Hereinafter, the specifications of the heating coil 442 having a resistance of 1.0 ohm to 1.3 ohms will be described.

The heating coil 442 may be wound around the central portion 441b of the wick 441 to form an outer diameter D2 of the central portion 441b. The outer diameter D1 of the wick 441 may be defined as the outer diameter D1 of the peripheral portion 441a. The outer diameter D2 of the central portion 441b may be smaller than the outer diameter D1 of the peripheral portion 441a. For example, the outer diameter D1 of the peripheral portion 441a may be about 2 mm to about 3.5 mm. In another example, the outer diameter D1 of the peripheral portion 441a may be about 2.5 mm to about 3.0 mm. For example, the outer diameter D2 of the central portion 441b may be about 1.8 mm to about 2.2 mm. In another example, the outer diameter D2 of the central portion 441b may be about 2 mm. The area of the region surrounded by the heating coil 442 may be determined based on the outer diameter D2 of the central portion 441b.

As described above, the length L2 of the heating coil 442 may be determined in consideration of the distance L3 from one of the wick grooves 434 to the other thereof. For example, the length L2 of the heating coil 442 may be 3.0 mm to 3.5 mm. In another example, the length L2 of the heating coil 442 may be 3.25 mm.

The wire of the heating coil 442 may be wound around the wick 441 such that the turns of wire are spaced apart from each other by a predetermined interval w in the longitudinal direction of the wick 441, rather than contacting each other. The interval w between the turns of wire of the heating coil 442 in the central portion 441b may be 0.38 mm to 0.42 mm. Accordingly, it is possible to prevent the occurrence of short due to contact between the turns of wire of the heating coil 442, through which current flows.

The heating coil 442 may be wound around the wick 441 such that the turns of wire do not interfere with each other within the range of the length L2 and the range of the diameter D2 in consideration of the area of a heated portion of the wick and the target resistance value. For example, the number of windings of the heating coil 442 around the wick 441 may be 7 to 9. In another example, the number of windings of the heating coil 442 around the wick 441 may be 8.

According to the above-described specifications of the heating coil 442, the heating coil 442 may be formed to have a gauge (Ga) and made of a material suitable for creating a resistance value of 1.0 ohm to 1.3 ohms. For example, the heating coil 442 may be formed to have a thickness of 20 Ga to 30 Ga. For example, the heating coil 442 may be formed to have a thickness of 22 Ga, 24 Ga, 26 Ga, 28 Ga, or 30 Ga. For example, the heating coil 442 may be made of any one metal among Kanthal, nichrome, and stainless steel. For example, the heating coil 442 may be made of 316L stainless steel, which is one grade of stainless steel. However, the gauge and the material of the heating coil 442 may be appropriately combined.

In one embodiment of the present disclosure, the wick 441 may be a silica wick. In this case, the electrical resistance of the heating coil 442 may be 1.10 ohms to 1.20 ohms. In this case, the electrical resistance of the heating coil 442 may include a value of 1.15 ohms. In this case, in order to satisfy the electrical resistance condition of the heating coil 442, the heating coil 442 may be wound around the wick 441 eight times within the range of the length L2, which is about 3.25 mm, in the longitudinal direction of the wick 441. In this case, the outer diameter of the wick 441 may be about 2.5 mm. In this case, the heating coil 442 may be wound such that the turns of coil do not contact each other. In this case, the heating coil 442 may include 316L stainless steel, which is one grade of stainless steel. As a result of analyzing the evaporated components of glycerin through the aerosol-generating device including the cartridge according to this embodiment, it can be seen that the aerosol-generating device effectively prevents pyrolysis. As a result, the aerosol-generating device may prevent the wick 441 from being burned due to excessive increase in the temperature of the heating coil 442, thereby stably providing an aerosol to the user.

Referring to FIGS. 1 to 9, a cartridge in accordance with one aspect of the present disclosure may include a first chamber configured to store liquid; a second chamber configured to allow air to pass therethrough; a wick extending across the second chamber and configured to receive the liquid from the first chamber; and a heating coil configured to heat the wick, wherein the wick is a silica wick, and wherein the heating coil has an electrical resistance in a range of 1.0 ohm to 1.3 ohms.

In addition, in accordance with another aspect of the present disclosure, wherein the electrical resistance of the heating coil may be 1.15 ohms.

In addition, in accordance with another aspect of the present disclosure, wherein the electrical resistance of the heating coil may be in a range of 1.20 ohms to 1.25 ohms.

In addition, in accordance with another aspect of the present disclosure, wherein the heating coil may have a length of 3.0 mm to 3.5 mm in a longitudinal direction of the wick, and is wound seven to nine times around the wick.

In addition, in accordance with another aspect of the present disclosure, the heating coil may be wound eight times around the wick.

In addition, in accordance with another aspect of the present disclosure, the heating coil may include a wire wound around the wick such that the turns of wire are spaced apart from each other by an interval w of 0.38 mm to 0.42 mm in the longitudinal direction of the wick.

In addition, in accordance with another aspect of the present disclosure, the cartridge may further include a pair of wick grooves formed at opposite sides of the second chamber each configured to accommodate a corresponding end of the wick, wherein the heating coil may be wound around the wick between the pair of wick grooves, and wherein a distance between the pair of wick grooves may be in a range of 4.7 mm to 5.1 mm.

In addition, in accordance with another aspect of the present disclosure, the wick may have a length L1 of 6 mm to 12 mm.

In addition, in accordance with another aspect of the present disclosure, the wick may have an outer diameter D1 of 2.5 mm to 3.0 mm.

In addition, in accordance with another aspect of the present disclosure, the outer diameter D1 of the wick may be 2.5 mm.

In addition, in accordance with another aspect of the present disclosure, the central portion of the wick around which the heating coil is wound may have an outer diameter D2 of 1.9 mm to 2.1 mm, and the peripheral portion of the wick around which the heating coil is not wound may have an outer diameter D1 of 2.5 mm to 3.0 mm.

In addition, in accordance with another aspect of the present disclosure, the cartridge may further include leads electrically connected to two ends of the heating coil and extending away from the wick, wherein the leads may be made of a material having a lower temperature coefficient of resistance (TCR) than a material of the heating coil.

In addition, in accordance with another aspect of the present disclosure, the heating coil may be made of any one of Kanthal, nichrome, or stainless steel, and the leads may be made of any one of nickel, gold, or silver.

In addition, in accordance with another aspect of the present disclosure, the heating coil may include 316L stainless steel.

An aerosol-generating device in accordance with one aspect of the present disclosure may include a body configured to allow the cartridge to be coupled thereto; and an elongated insertion space defined in the body and configured to allow communication between the cartridge and an outside of the aerosol generating device.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A cartridge comprising:
a first chamber configured to store liquid;
a second chamber configured to allow air to pass therethrough;
a wick extending across the second chamber and configured to receive the liquid from the first chamber; and
a heating coil configured to heat the wick,
wherein the wick is a silica wick, and
wherein the heating coil has an electrical resistance in a range of 1.0 ohm to 1.3 ohms.

2. The cartridge according to claim 1, wherein the electrical resistance of the heating coil is 1.15 ohms.

3. The cartridge according to claim 1, wherein the electrical resistance of the heating coil is in a range of 1.20 ohms to 1.25 ohms.

4. The cartridge according to claim 1, wherein the heating coil has a length of 3.0 mm to 3.5 mm in a longitudinal direction of the wick, and is wound seven to nine times around the wick.

5. The cartridge according to claim 4, wherein the heating coil is wound eight times around the wick.

6. The cartridge according to claim 4, wherein the heating coil comprises a wire wound around the wick such that turns of the wire are spaced apart from each other by an interval of 0.38 mm to 0.42 mm in the longitudinal direction of the wick.

7. The cartridge according to claim 4, further comprising:
a pair of wick grooves formed at opposite sides of the second chamber each configured to accommodate a corresponding end of the wick,
wherein the heating coil is wound around the wick between the pair of wick grooves, and
wherein a distance between the pair of wick grooves is in a range of 4.7 mm to 5.1 mm.

8. The cartridge according to claim 7, wherein the wick has a length of 6 mm to 12 mm.

9. The cartridge according to claim 1, wherein the wick has an outer diameter of 2.5 mm to 3.0 mm.

10. The cartridge according to claim 9, wherein the outer diameter of the wick is 2.5 mm.

11. The cartridge according to claim 9, wherein a central portion of the wick around which the heating coil is wound has an outer diameter of 1.9 mm to 2.1 mm, and
wherein a peripheral portion of the wick around which the heating coil is not wound has an outer diameter of 2.5 mm to 3.0 mm.

12. The cartridge according to claim 1, further comprising:
leads electrically connected to two ends of the heating coil and extending away from the wick, wherein the leads are made of a material having a lower temperature coefficient of resistance (TCR) than a material of the heating coil.

13. The cartridge according to claim 12, wherein the heating coil is made of any one of Kanthal, nichrome, or stainless steel, and
wherein the leads are made of any one of nickel, gold, or silver.

14. The cartridge according to claim 1, wherein the heating coil comprises 316L stainless steel.

15. An aerosol-generating device comprising:
the cartridge described in claim 1;
a body configured to allow the cartridge to be coupled thereto; and
an elongated insertion space defined in the body and configured to allow communication between the cartridge and an outside of the aerosol generating device.
